(19) United States
(12) Patent Application Publication
(10) Pub. No.: US 2005/0111435 A1
(43) Pub. Date: May 26, 2005

(54) [INTERNET-PROTOCOL (IP) PHONE WITH BUILT-IN GATEWAY AS WELL AS TELEPHONE NETWORK STRUCTURE AND MULTI-POINT CONFERENCE SYSTEM USING IP PHONE]

(76) Inventor: JAMES YANG, HSINCHU CITY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,195

(22) Filed: Nov. 26, 2003

(51) Int. Cl. H04L 12/66

(52) U.S. Cl. 370/352

(57) ABSTRACT

An internet-protocol (IP) phone having a built-in network gateway with three terminals is provided. A signal entering from one terminal can be simultaneously converted and transmitted to the other two terminals. The three terminals include an IP terminal, a POTS terminal and a local phone terminal. Moreover, a multiple of the aforementioned IP phones can be cascaded together through common IP terminals or POTS terminals to form a telephone network. In addition, at least one other telephone can be optionally coupled to the telephone network. The other telephone can be different from the IP phone with the built-in gateway. As a result, all users connected to the telephone network can hold a conference.

### BACKGROUND OF INVENTION

1. Field of the Invention

The present invention relates to an internet-protocol (IP) phone. More particularly, the present invention relates to an internet-protocol (IP) phone having a built-in gateway with three terminals capable of cascading with each other to form a telephone network.

2. Description of the Related Art

Information exchange has become an indispensable part in our daily life ever since the rapid development of information technology and equipment. Nowadays, a ‘plain old telephone service’ (POTS) phone is still one of the major channels for the transmission of information. However, the cost of making a long distance call through a conventional telephone line is quite expensive. With the development of network technologies, internet-protocol (IP) phones have become popular. Due to the potential for great monetary earnings through subscriptions, a few companies often negotiate a deal to monopolize the use of such a network.

Video conferencing is another arrangement that can be carried out through a telephone network at whatever time one desires. Because the parties involved in a teleconferencing session need not assemble together in a designated location, considerable traveling time and cost are saved. Nevertheless, most IP phones have to conduct a communication session through an IP interface. FIG. 1 is a schematic diagram showing the connections of a conventional telephone network. As shown in FIG. 1, the telephone network has a POTS telephone interface 100. A conventional telephone 102 may connect with the POTS telephone interface 100. The POTS telephone interface 100 is connected to an IP interface 106 through an acoustic network gateway 104. Thereafter, the IP interface 106 may connect with a voice telephone 110, a broadband audio/video telephone 112 or a multiple-conferencing unit (MCU) 108. To initiate a conference session, for example, an initiator may pick up a phone 102 and call for a conference through the multiple-conferencing unit 108.

However, due to some intrinsic functional limitations of the multiple-conferencing unit, the number of people that can take part in a given conference is restricted. Furthermore, if the POTS telephone line is too long, insertion loss may lead to the frequent occurrence of communication errors. Consequently, the provision of an IP phone design capable of increasing the efficiency and clarity of a teleconferencing session is a major target for network researchers.

### SUMMARY OF INVENTION

Accordingly, at least one objective of the present invention is to provide an internet-protocol (IP) phone with a built-in gateway such that any number of the IP phone can be connected to form a telephone network structure. Hence, a conference can be carried out through the telephone network.

At least a second objective of this invention is to provide a cascade connected wireless telephone network system with three-way communication function.

To achieve these and other advantages and in accordance with the purpose of the invention, as embodied and broadly described herein, the invention provides an IP phone with a built-in gateway. The IP phone comprises a built-in gateway with an IP terminal, a plain old telephone service (POTS) terminal and a local telephone terminal. A signal entering from one terminal can be simultaneously converted and transmitted to the other two terminals.

This invention also provides a telephone network structure. The telephone network structure comprises a multiple of the aforementioned IP phones cascaded together through an identical type of IP or POTS terminal. In addition, at least another telephone can be optionally coupled to the telephone network. The other telephone can be different from the aforementioned IP phones. As a result, all users connected to the telephone network can hold a conference.

In the aforementioned telephone network structure, the internal connection point is connected to at least a local telephone.

In the aforementioned telephone network structure, the front and back terminals are both IP mode terminals.

In the aforementioned telephone network structure, the front and back terminals are both POTS mode terminals.

In the aforementioned telephone network structure, the front and back terminals are POTS mode terminal and an IP mode terminal respectively.

This invention also provides a multiple-point conference system having multiple connections that permit simultaneous communication between a number of users. The multi-point conference system comprises at least an IP phone. Each IP phone provides at least an IP terminal, a POTS terminal and a local telephone terminal. A signal entering from any one of the three terminals can be simultaneously converted and transmitted to the other two terminals. Furthermore, neighboring IP phones are connected through identical IP terminals or POTS terminals to form a telephone network. Hence, participants in a conference may use the telephone network to conduct a conference.

In the aforementioned multi-point conference system, at least one of the IP phones can be connected to another telephone.

In the aforementioned multi-point conference system, at least one of the IP phones can be connected to another telephone exchange system.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing the connections of a conventional telephone network.

FIG. 2 is a schematic diagram showing the connection of a conventional telephone network.

FIG. 3 is a schematic diagram showing a gateway design according to this invention.

FIG. 4 is a schematic diagram showing a telephone network connection according to this invention.

FIGS. 5 through 8 are schematic diagrams showing various types of telephone network connections according to this invention.

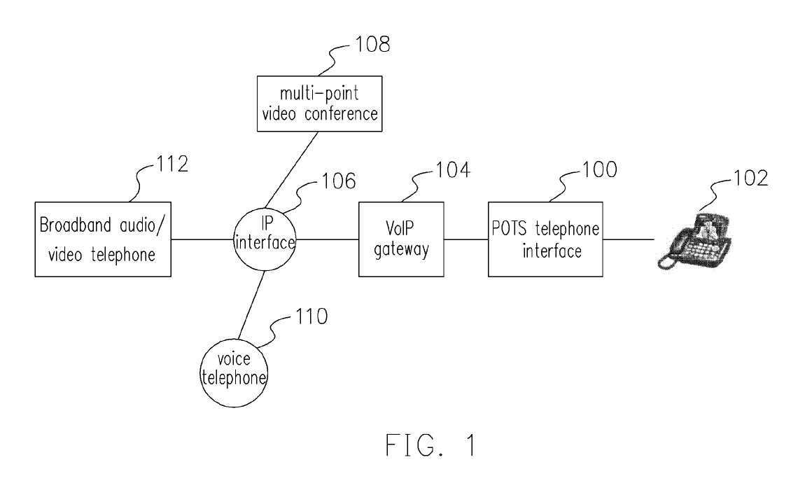

### DETAILED DESCRIPTION

References will now be made in detail to the present preferred embodiments of the invention, examples of which are illustrated in the accompanying drawings. Wherever possible, the same reference numbers are used in the drawings and the description to refer to the same or like parts.

This invention provides an internet-protocol (IP) phone with a built-in gateway. Any number of these IP phones can be connected together to form a telephone network structure so that a teleconference between people holding the IP phones may proceed.

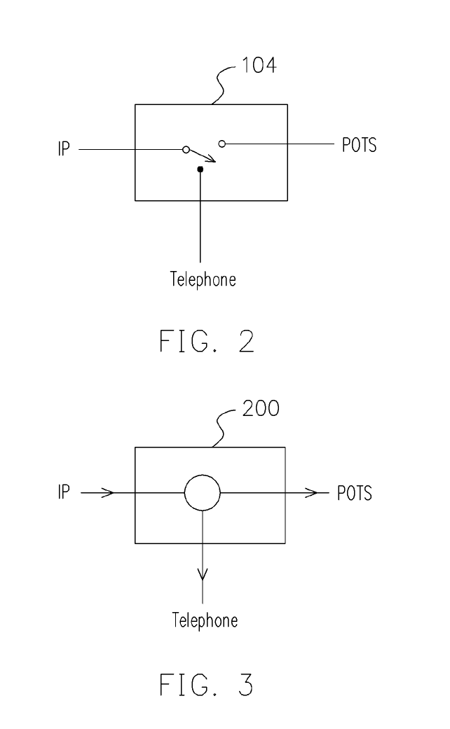

First, an IP phone with a built-in gateway is provided. The gateway has an IP terminal, a POTS terminal and a local telephone terminal. A signal is permitted to enter from any one of the three terminals and transmitted to the other two terminals with the necessary signal conversion. This type of gateway differs from a conventional gateway (refer to FIG. 2). FIG. 3 is a schematic diagram showing a gateway design according to this invention. As shown in FIG. 3, the gateway 200 combines the three terminals together to form a node. For example, a signal entering from the IP terminal can be simultaneously converted into POTS signal format for outputting to the POTS terminal as well as local telephone signal format for outputting to the local telephone terminal.

A hardware circuit with the aforementioned gateway functions can be designed by engineers who are familiar with circuit designs.

In general, an unlimited number of the aforementioned IP phones may be stringed together in cascade to form a telephone network for conducting a teleconference.

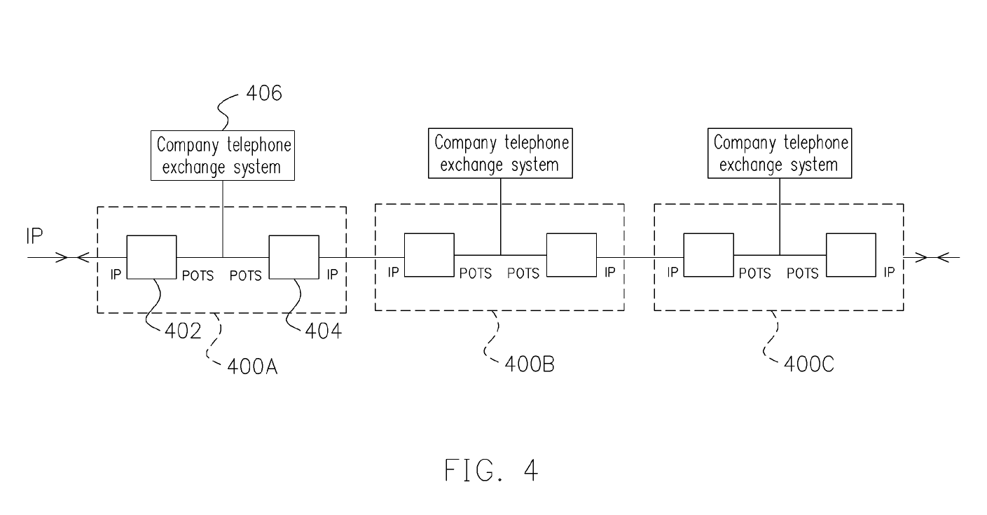

FIG. 4 is a schematic diagram showing a telephone network connection according to this invention. Obviously, permissible telephone network structures are not limited to the one in FIG. 4. However, a system using POTS telephones incur the least operating cost. For example, inside a company, typical telephone communication is conducted through an internal telephone exchange system. Yet, outside and remote telephone communication is conducted in an IP mode. Hence, two IP phones 402, 404 each with a built-in gateway may be combined to form an integrated unit 400A. For the two IP phones within the unit 400A, their POTS terminal are joined together to form an internally connected terminal. The internally connected terminal may connect with a local or a company exchange system 406. Thus, the IP phones 402 and 404 as well as the other POTS telephones of the company are joined together to form an integrative communication system.

Furthermore, one of the IP terminals of the IP phones 402 and 404 in the integrative unit 400A may be connected to an external device while the other IP terminal may be connected to another integrative unit 400B. Similarly, the integrative unit 400B may be connected to yet another integrated unit 400C and so on. In this way, a cascade of units are joined together to form a telephone network. The number of units that can be stringed together is unlimited. However, the number of units in the cascade depends on the actual requirements. Furthermore, the front and back IP terminal of the telephone network, that is, the terminal on the far right and far left, may connect with a conventional IP phone or an IP phone designed according to this invention.

In addition, the POTS terminals need not be the internally connected terminal in the connective structure of the unit 400A. Moreover, the number of IP phones in a single unit within the telephone network is not limited to two either.

After forming a cascade of IP phones in this way, each telephone user may participate in a teleconference simultaneously with all other users.

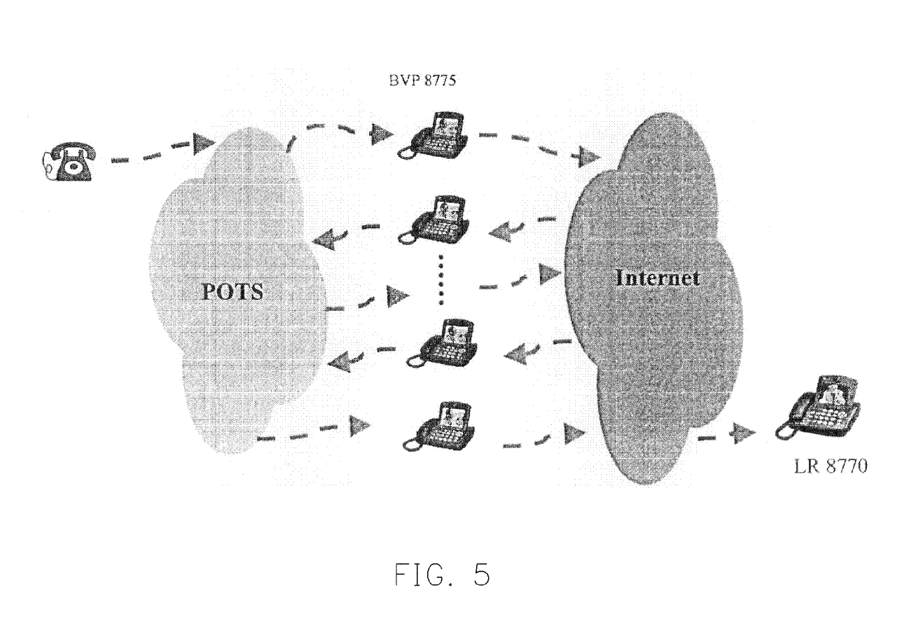

FIGS. 5 through 8 are schematic diagrams showing various types of telephone network connections according to this invention. First, as shown in FIG. 5, IP phones with a built-in gateway according to this invention, for example, broadband video phones labeled BVP 8775 are connected to an Internet interface. Conventional POTS telephones are connected to the POTS interface externally. Similarly, conventional IP phone labeled BVP 8770 are connected to the Internet interface externally. With this type of connection, the basic pattern of connection is: POTS-(POTS-IP)-(IP-POTS)-(POTS-IP) . . . (IP-POTS)-(POTS-IP)-IP. Here, (POTS-IP) or (IP-POTS) represents the IP phones with built-in gateway according to this invention. Furthermore, the telephone connected to the very front and back terminal of the telephone network can be a conventional telephone or a telephone designed according to this invention. In FIG. 5, the direction of arrows gives an example of the direction of communication inside the telephone network starting from an external POTS phone. Furthermore, the Internet interface may also connect with at least any one type of IP phone including, for example, a conventional IP phone or an IP phone of this invention.

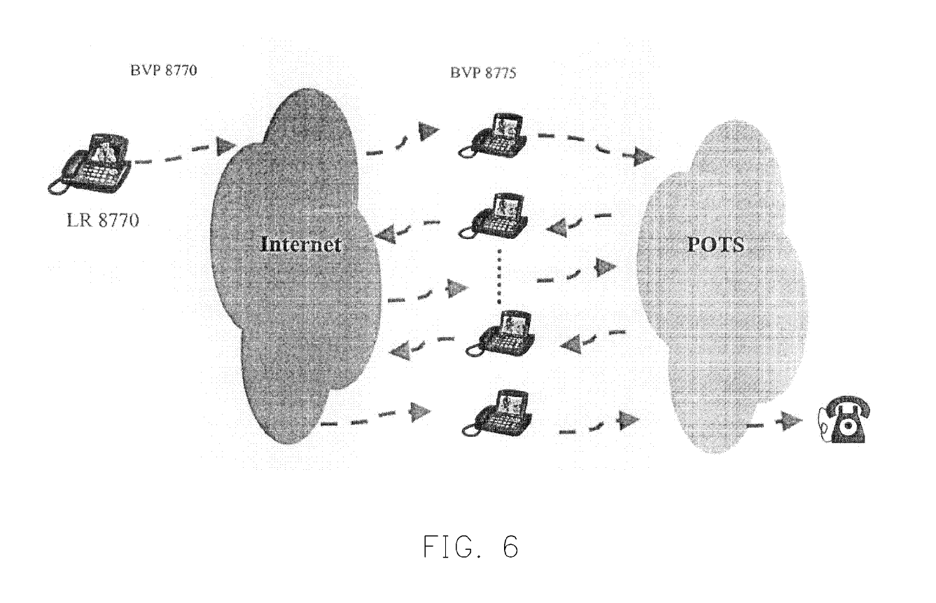

FIG. 6 shows another telephone network connection similar to the one in FIG. 5. The initiator is a conventional LR 8770 telephone. The POTS interface may further connect with at least a POTS telephone. However, the initiator of the telephone network can also be an IP phone with built-in gateway according to this invention. The basic pattern of connection is:IP (IP-POTS) (POTS-IP) (IP-POTS) (POTS-IP) . . . (IP-POTS) POTS. Here, the starting IP phone can be a conventional IP phone or an IP phone with built-in gateway.

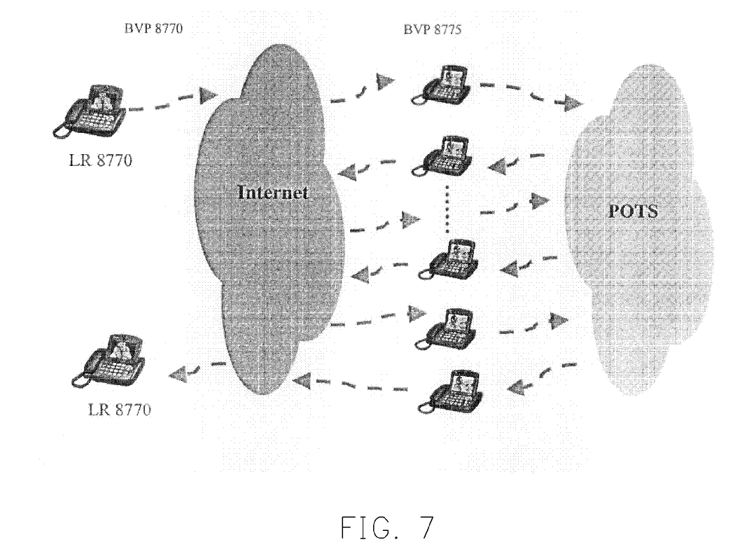

FIG. 7 shows yet another telephone network connection. The initiator is a conventional IP phone LR8770, for example. Through the Internet interface and the POTS interface, a number of IP phones with built-in gateway are stringed together in cascade. Finally, another IP phone that can be a conventional IP phone or an IP phone with built-in gateway is connected to the Internet interface. The basic pattern of connection is:IP (IP-POTS)-(POTS-IP)-(IP-POTS) . . . (POTS-IP) IP. Here, the two IP phones at the very front and at the very back of the string can be a conventional IP phone or an IP phone according to this invention.

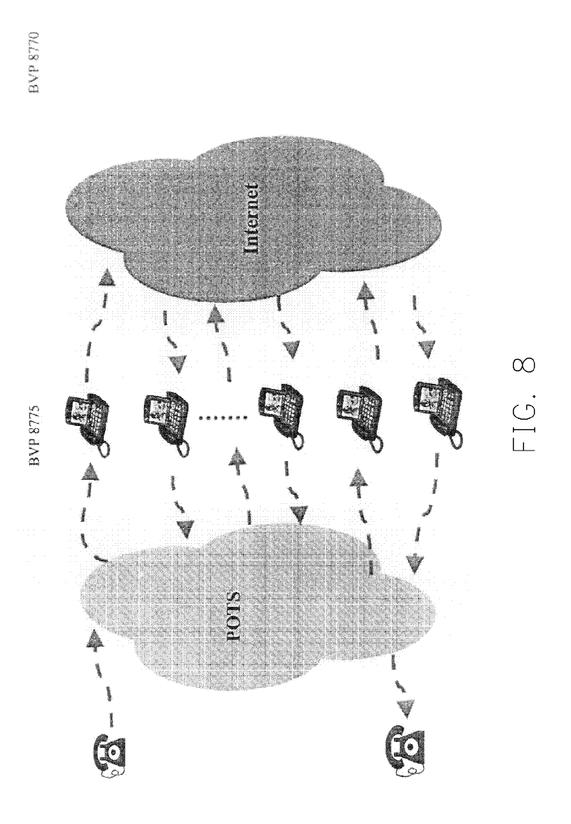

FIG. 8 shows yet another telephone network connection. The initiator is a conventional POTS telephone, for example. Through the POTS interface and the Internet interface, a number of IP phones with built-in gateway are stringed together in cascade. Finally, another POTS telephone is connected to the POTS interface. The basic pattern of connection is: POTS (POTS-IP) (IP-POTS)-(POTS-IP) . . . (IP-POTS) POTS. In other words, the telephone network of this invention at least uses an IP phone with built-in gateway. The IP terminal and the POTS terminal of the IP phone may connect with any type of telephone having an identical connective mode, in particular, another IP phone with built-in gateway. Hence, the aforementioned telephone network structures may also be linked together through the IP interface or the POTS interface, for example: IP (IP-POTS) POTS (POTS-IP) (IP-POTS) . . . (POTS-IP) IP (IP-POTS) POTS. Therefore, the IP terminals and the POTS terminals of the IP phones can be utilized to form various types of telephone network connections. In this way, the number of users no longer limits the teleconferencing function.

Furthermore, the IP phones with built-in gateway along the telephone network may also connect with a local telephone exchange system such as the telephone network system within a company.

In addition, if economics is a major consideration, local or telephone network system within a company may deploy the POTS mode. The IP mode is activated only when external communication is required. For example, a company only has to provide a unit such as the unit 400A in FIG. 4 in preparation for connecting with some other units such as the unit 400B.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An internet-protocol (IP) phone with a built-in gateway, comprising:
a built-in network gateway having an IP terminal, a plain old telephone service (POTS) terminal and a local telephone terminal, wherein a signal entering any one of the three terminals is permitted to convert and transmit to the other two terminals simultaneously.

2. A telephone network structure, comprising:
at least one internet-protocol (IP) phone with a built-in gateway, wherein the IP phone with the built-in gateway has an IP terminal, a plain old telephone service (POTS) terminal and a local telephone terminal such that a signal entering any one of the three terminals is permitted to convert and transmit to the remaining terminals simultaneously,
wherein the at least one IP phone with the built-in gateway connects together in series by the IP terminal and the POTS terminal to form a telephone network, and all of the IP phone with the built-in gateway server a function of telephone conference.

3. The telephone network structure of claim 2, wherein the serially connected IP phones with the built-in gateway comprise at least a unit assembled from a pair of IP phones such that the POTS terminals are an internally connected point and the IP terminals are externally connected.

4. The telephone network structure of claim 3, wherein the internally connected point also connects with a local telephone.

5. The telephone network structure of claim 2, wherein both the front and the end terminals of the telephone network structure operate in an IP mode.

6. The telephone network structure of claim 2, wherein both the front and the end terminal of the telephone network structure operate in a POTS mode.

7. The telephone network structure of claim 2, wherein the front and the end terminal of the telephone network structure operates in a POTS mode and an IP mode respectively.

8. The telephone network structure of claim 2, wherein the IP phone with a built-in gateway processes voice signals.

9. The telephone network structure of claim 2, wherein the IP phone with a built-in gateway processes both voice and video signals.

10. A telephone network system, comprising:
at least an internet-protocol (IP) phone, wherein at least one of the IP phone has a built-in gateway providing an IP terminal, a plain old telephone service (POTS) terminal and a local telephone terminal such that a signal entering any one of the three terminals is permitted to convert and transmit to the remaining terminals simultaneously,
wherein IP terminals or POTS terminals of two neighboring IP phones are serially connected together in the same mode to form a telephone network.

11. The telephone network system of claim 10, wherein the serially connected IP phones comprise at least a unit assembled from a pair of IP phones with the built-in gateway such that the POTS terminals are an internally connected point and the IP terminals are externally connected.

12. The telephone network system of claim 11, wherein the internally connected point also connects with a local telephone exchange system.

13. The telephone network system of claim 10, wherein both the front and the end terminal of the telephone network operate in an IP mode.

14. The telephone network system of claim 10, wherein both the front and the end terminal of the telephone network operate in a POTS mode.

15. The telephone network system of claim 10, wherein the front and the end terminal of the telephone network operates in a POTS mode and an IP mode respectively.

16. A multi-point conferencing system for conducting a communication session between a number of users simultaneously, comprising:
at least an internet-protocol (IP) phone, wherein the IP phone has an IP terminal, a plain old telephone service (POTS) terminal and a local telephone terminal such that a signal entering any one of the three terminals is permitted to convert and transmit to the remaining terminals simultaneously and identical IP terminals or POTS terminals of neighboring IP phones are serially connected together to form a telephone network; and
a plurality of conference participants using the telephone network to conduct a conference session.

17. The multi-point conference system of claim 16, wherein at least one of the IP phones also connects with another telephone.

18. The multi-point conference system of claim 16, wherein at least one of the IP phones also connects with a telephone exchange system.
